(19) United States
(12) Patent Application Publication
(10) Pub. No.: US 2016/0111699 A1
(43) Pub. Date: Apr. 21, 2016

(54) ELECTRODE ASSEMBLY BLOCK AND METHOD OF MANUFACTURING THE SAME, AND SECONDARY BATTERY AND METHOD OF MANUFACTURING THE SAME

(71) Applicant: Samsung SDI Co., Ltd., Yongin-si (KR)

(72) Inventors: Changbum Ahn, Yongin-si (KR); Kyugil Choi, Yongin-si (KR); Jakyung Cho, Yongin-si (KR)

(21) Appl. No.: 14/981,843

(22) Filed: Dec. 28, 2015

Related U.S. Application Data
(63) Continuation of application No. 12/961,391, filed on Dec. 6, 2010.

(30) Foreign Application Priority Data
Dec. 7, 2009 (KR) 10-2009-0120262

(51) Int. Cl. H01M 2/16; H01M 2/18; H01M 4/62; H01M 10/0585

(52) U.S. Cl. CPC H01M 2/168; H01M 10/0585; H01M 2/18; H01M 4/623

(57) ABSTRACT

An electrode assembly block includes a first electrode plate including a first electrode collector plate and a first electrode tab; a first separator on a bottom surface of the first electrode plate and a second separator on a top surface of the first electrode plate, to cover the first electrode collector plate between the first separator and the second separator while allowing a portion of the first electrode tab to be exposed; and a second electrode plate on a bottom surface of the first separator or a top surface of the second separator, the second electrode plate including a second electrode collector plate and a second electrode tab, the second electrode plate corresponding to the first electrode plate, wherein edge regions of the first separator and the second separator are fused together, and the second electrode plate is adhered to the first separator or the second separator.

### CROSS-REFERENCE TO RELATED APPLICATION

This application is a continuation of U.S. patent application Ser. No. 12/961,391, filed on Dec. 6, 2010, which claims priority to and the benefit of Korean Patent Application No. 10-2009-0120262, filed in the Korean Intellectual Property Office on Dec. 7, 2009, the entire contents of both of which are incorporated herein by reference.

### BACKGROUND

1. Field

An embodiment of the present invention relates to an electrode assembly block, a method of manufacturing the electrode assembly block of a secondary battery and a method of manufacturing the secondary battery.

2. Description of Related Art

An electrode assembly of a secondary battery may be classified into a wound electrode assembly, a stacked electrode assembly or a stacked/folded electrode assembly according to the construction of the electrode assembly.

The wound electrode assembly is manufactured by first stacking a second electrode plate and a first electrode plate in a long sheet shape with a separator interposed therebetween, then winding the stack into a jelly roll shape. The stacked electrode assembly is manufactured by sequentially stacking a plurality of second electrode plates and first electrode plates, which have been cut into a set or predetermined size, while separators are disposed respectively between the first and second electrodes. The stacked/folded electrode assembly is manufactured by winding pluralities of bi-cells or full-cells successively stacked while separators are disposed respectively between the first and second electrodes, using a long separator sheet.

### SUMMARY

An aspect of an embodiment of the present invention provides a secondary battery including a second electrode plate, a separator and a first electrode plate that are precisely aligned.

In one embodiment of the present invention, an electrode assembly block includes a first electrode plate including a first electrode collector plate and a first electrode tab; a first separator on a bottom surface of the first electrode plate and a second separator on a top surface of the first electrode plate, to cover the first electrode collector plate between the first separator and the second separator while allowing a portion of the first electrode tab to be exposed; and a second electrode plate on a bottom surface of the first separator or a top surface of the second separator, the second electrode plate including a second electrode collector plate and a second electrode tab, the second electrode plate corresponding to the first electrode plate, wherein edge regions of the first separator and the second separator are fused together, and the second electrode plate is adhered to the first separator or the second separator.

In an embodiment of the present invention, the edge regions of the first separator and the second separator may be ultrasonic fused together.

The second electrode plate may be adhered to the first separator or the second separator by an adhesive.

In addition, the adhesive may be a polyvinylidene fluoride (PVDF) binder.

Further, the first electrode tab and the second electrode tab may be spaced apart from each other in a longitudinal direction of the electrode assembly block.

In one embodiment of the present invention, a secondary battery includes a stacked electrode assembly in which at least two of the electrode assembly block are stacked and aligned with respect to the first separator or the second separator.

In one embodiment of the present invention, a method of manufacturing an electrode assembly block includes stacking one or more first electrode plates on a top surface of a first separator sheet such that a portion of a first electrode tab of each of the one or more first electrode plates protrudes from one side of the first separator sheet; stacking a second separator sheet on the one or more first electrode plates, the second separator sheet corresponding to the first separator sheet; adhering one or more second electrode plates to the second separator sheet such that a bottom surface of each of the one or more second electrode plates is adhered to a top surface of the second separator sheet, each of the one or more second electrode plates corresponding to a respective of the one or more first electrode plates; cutting the first separator sheet and the second separator sheet into a set size by cutting along cutting lines spaced apart from lateral surfaces of each of the one or more first electrode plates and the one or more second electrode plates to form one or more corresponding border portions of each of the first separator sheet and the second separator sheet, the one or more corresponding border portions each extending from the lateral surfaces of each of the one or more first electrode plates and the one or more second electrode plates; and adhering each of the one or more corresponding border portions of the first separator sheet and the second separator sheet.

The stacking of the one or more first electrode plates may include placing the one or more first electrode plates on the top surface of the first separator sheet such that a portion of the first electrode tab of each of the one or more first electrode plates protrudes from one end of the first separator sheet, and adhering at least a portion of the bottom surface of each of the one or more first electrode plates to the top surface of the first separator sheet.

The stacking of the second separator sheet may include forming the second separator sheet by placing the second separator sheet on the one or more first electrode plates corresponding to the first separator sheet, and adhering a portion of a bottom surface of each of the one or more second electrode plates to the top surface of the second separator sheet.

Further, the adhering of the one or more second electrode plates may include adhering the one or more second electrode plates using a polyvinylidene fluoride (PVDF) binder.

In addition, the cutting of the first separator sheet and the second separator sheet may be performed by heat cutting.

The adhering of the one or more corresponding border portions of the first separator sheet and the second separator sheet may be performed by ultrasonic fusion.

In one embodiment of the present invention, a method of manufacturing a secondary battery includes sequentially stacking two or more electrode assembly blocks each manufactured by any of the methods described above, and aligning the two or more electrode assembly blocks with respect to the first separators or the second separators of at least one of the two or more electrode assembly blocks.

Additional aspects and/or advantages of the invention will be set forth in part in the description which follows and, in part, will be obvious from the description, or may be learned by practice of the invention.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a stacked electrode assembly according to an embodiment of the present invention.

FIG. 2 is a perspective view of an electrode assembly block shown in FIG. 1.

FIG. 3 is an exploded perspective view of the electrode assembly block shown in FIG. 2.

FIG. 4 is a sectional view taken along line A-A′ of FIG. 2.

FIG. 5A is a plan view of a first electrode plate shown in FIG. 1.

FIG. 5B is a plan view of the first electrode plate shown in FIG. 5A from which a first electrode active material layer is removed.

FIG. 6A is a plan view of a second electrode plate shown in FIG. 1.

FIG. 6B is a plan view of the second electrode plate shown in FIG. 6A from which a second electrode active material layer is removed.

FIG. 7 is a flowchart schematically illustrating processing steps in a method of manufacturing an electrode assembly block according to an embodiment of the present invention.

FIGS. 8 through 13B are plan views, and sectional views schematically illustrating the method illustrated in FIG. 7.

FIG. 14 is a flowchart illustrating a method of manufacturing a stacked electrode assembly according to an embodiment of the present invention.

FIGS. 15A through 17 are plan views, sectional views, and a perspective view schematically illustrating processing steps in the method illustrated in FIG. 14.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

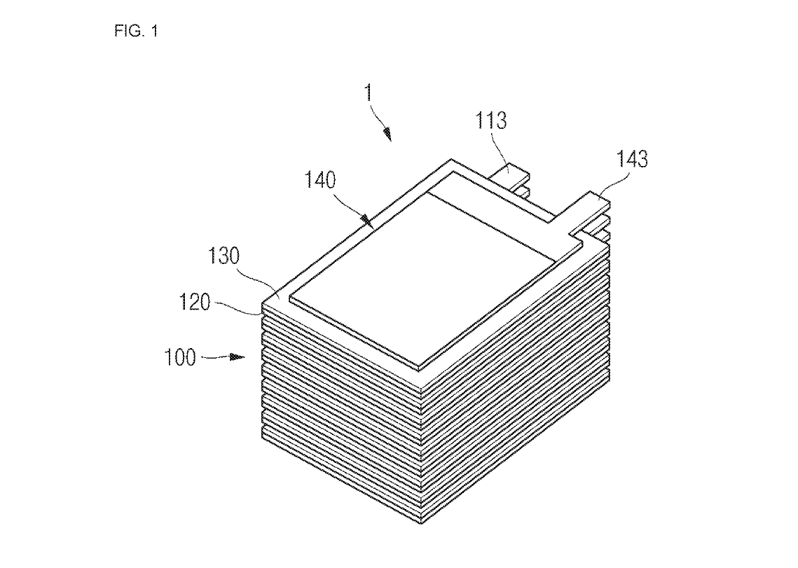

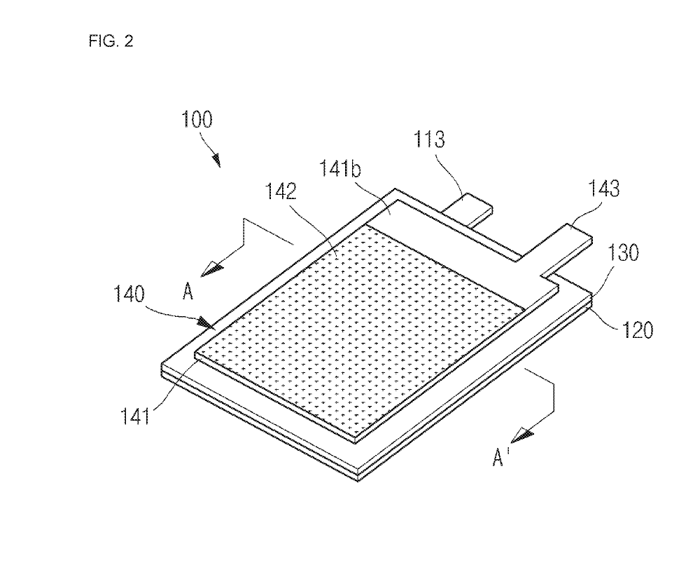

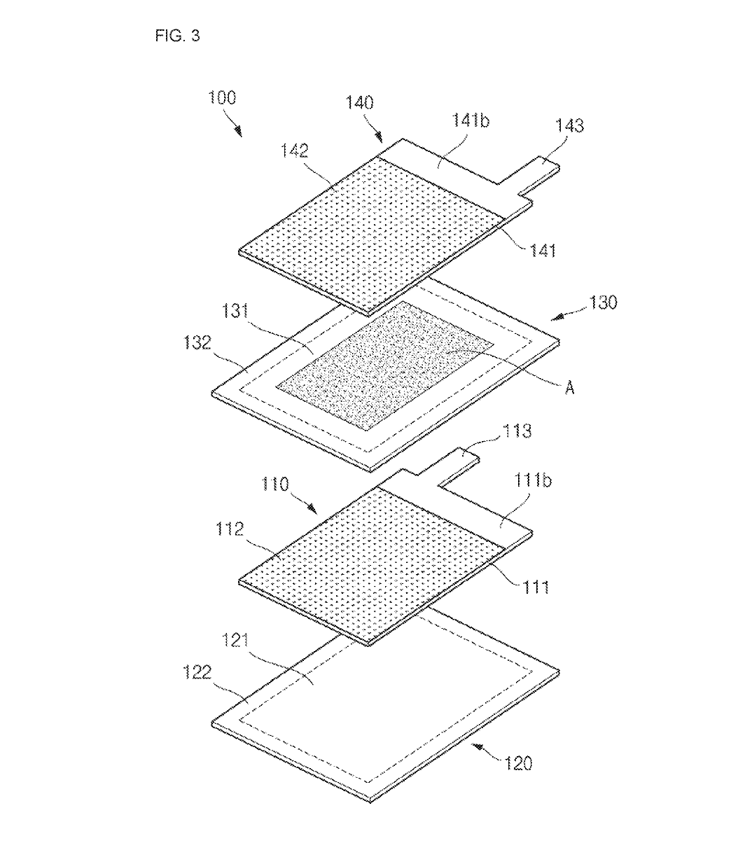

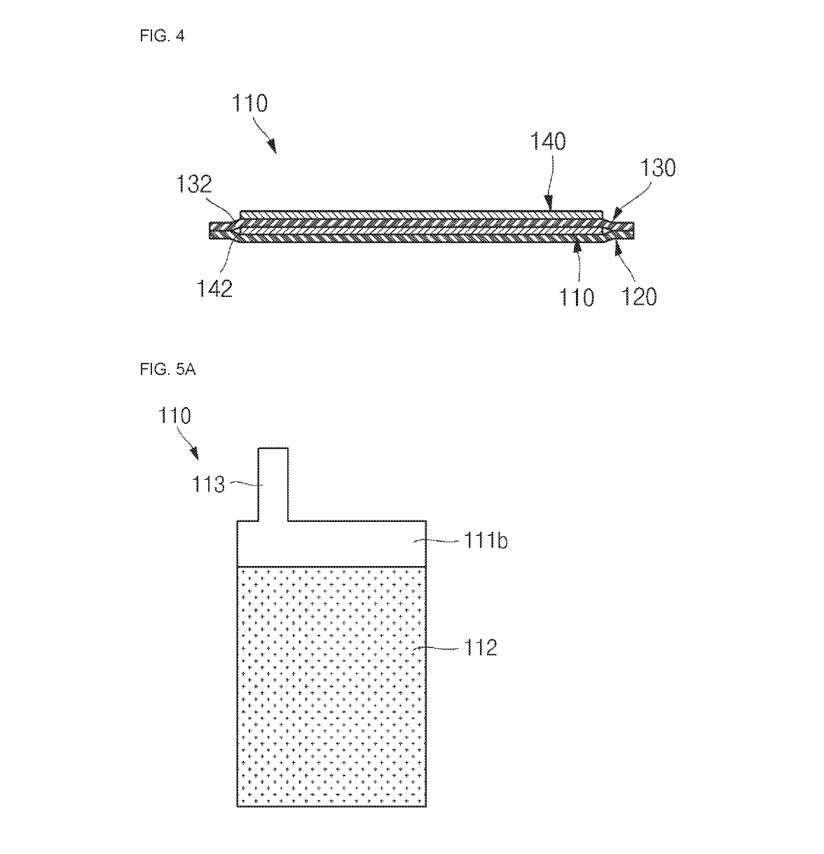

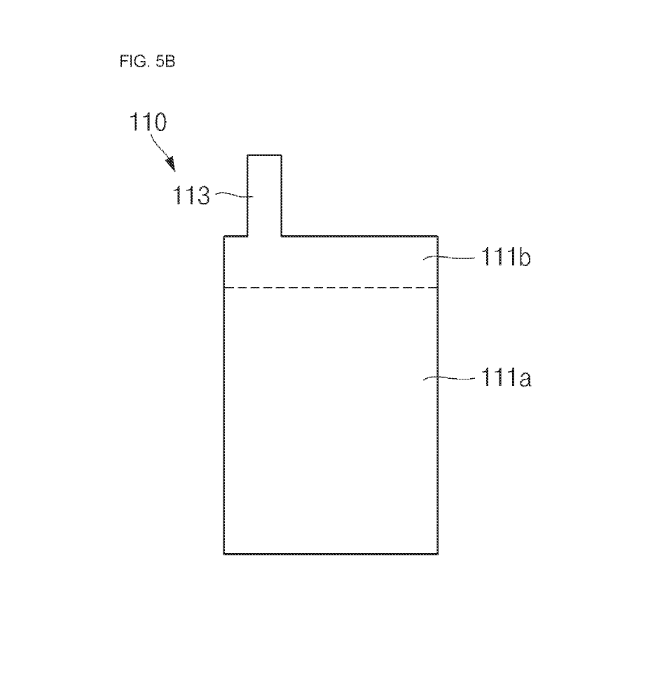

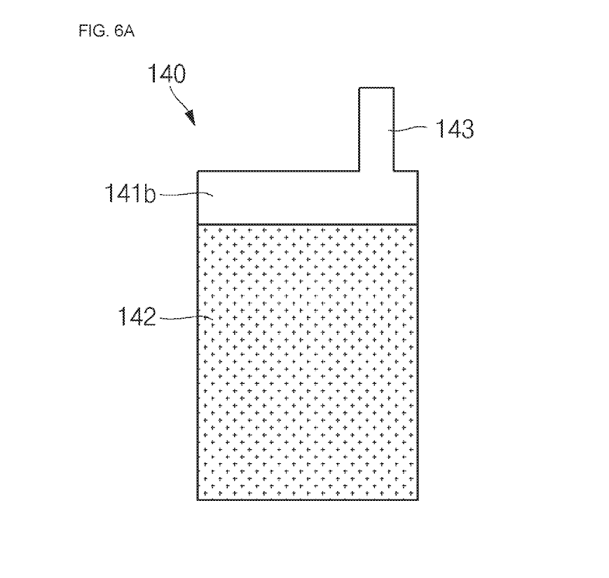

Hereinafter, a stacked electrode assembly according to an embodiment of the present invention will be described in detail with reference to FIGS. 1 through 6B. FIG. 1 is a perspective view of a stacked electrode assembly according to an embodiment of the present invention. FIG. 2 is a perspective view of an electrode assembly block shown in FIG. 1. FIG. 3 is an exploded perspective view of the electrode assembly block shown in FIG. 2. FIG. 4 is a sectional view taken along line A-A′ of FIG. 2. FIG. 5A is a plan view of a first electrode plate shown in FIG. 1. FIG. 5B is a plan view of the first electrode plate shown in FIG. 5A from which a first electrode active material layer is removed. FIG. 6A is a plan view of a second electrode plate shown in FIG. 1. FIG. 6B is a plan view of the second electrode plate shown in FIG. 6A from which a second electrode active material layer is removed.

A secondary battery according to an embodiment of the present invention includes a stacked electrode assembly 1. Referring to FIGS. 1 through 6B, the stacked electrode assembly 1 is constructed such that a plurality of electrode assembly blocks 100 are stacked.

Each of the plurality of electrode assembly blocks 100 may include a first electrode plate 110, a first separator 120, a second electrode plate 140 and a second separator 130. In one embodiment, the first electrode plate 110 is a negative electrode plate and the second electrode plate 130 is a positive electrode plate. In another embodiment, the first electrode plate 110 is a positive electrode plate and the second electrode plate 130 is a negative electrode plate.

A description will be made for one embodiment of the present invention where the first electrode plate 110 is a negative electrode plate and the second electrode plate 130 is a positive electrode plate, but aspects of the present invention are not limited thereto.

In one embodiment, the first electrode plate 110 includes a first electrode collector plate 111, a first electrode active material layer 112 and a first electrode tab 113.

In one embodiment, the first electrode collector plate 111 may have a thickness of 3 to 500 μm. The material of the first electrode collector plate 111 is not particularly limited as long as it has a sufficient electrical conductivity. For example, the first electrode collector plate 111 may be formed of copper, stainless steel, aluminum, nickel or the like. The first electrode collector plate 111 may have fine irregularities formed on its surface to reinforce bondability of the first electrode material layer 112, and the first electrode collector plate 111 may be formed into various suitable shapes, such as a film, a sheet, a foil, a net, a porous body or the like. Regarding FIG. 5B, the first electrode collector plate 111 of one embodiment includes a first electrode coating portion 111a and a first electrode non-coating portion 111b.

The first electrode coating portion 111a is a region coated with a first electrode active material thereon, and the first electrode non-coating portion 111b is a region of the first electrode collector plate 111 that is not coated with the first electrode active material thereon. The first electrode coating portion 111a and the first electrode non-coating portion 111b may be on a top surface and/or a bottom surface of the first electrode collector plate 111.

In one embodiment, the first electrode active material layer 112 is formed by coating the first electrode active material onto the first electrode coating portion 111a. The first electrode active material may be formed of carbon such as hard carbon, graphite or the like.

In one embodiment, the first electrode tab 113 is formed of copper (Cu). In one embodiment, the first electrode tab 113 is integrally provided with the first electrode collector plate 111 and extends from a side of the first electrode non-coating portion 111b. In another embodiment, the first electrode tab 113 may be provided such that one end of the first electrode tab 113 is adhered to a set or predetermined region of a side of the first electrode non-coating portion 111b. The first electrode tab 113 may be adhered to the first electrode non-coating portion 111b by any suitable method. An example of a suitable method includes ultrasonic welding, resistance welding and laser welding.

With regard to FIG. 3, the first separator 120 according to one embodiment is an insulating thin film having a high ion transmissivity and a high mechanical strength, and has a thickness of 5 to 300 μm. The first separator 120 is composed of a chemical-resistant and hydrophobic olefin polymer such as polypropylene or the like; and a sheet or non-woven fabric made of glass fiber or polyethylene or the like. In one embodiment, the first separator 120 has a multi-layered structure of a polyethylene film, a polypropylene film or combinations of these films; or a polymer film for a polymer electrolyte or gel-type polymer electrolyte, such as polyvinylidene fluoride, polyethylene oxide, polyacrylonitrile or a polyvinylidene fluoride hexafluoropropylene copolymer. In one embodiment, the first separator 120 includes a first base portion 121 and a first extending portion 122. The first separator 120 may be placed under the first electrode plate 110. A top surface of the first separator 120 may be adhered to a portion of the bottom surface of the first electrode plate 110.

In one embodiment, the first base portion 121 is positioned under the first electrode collector plate 111 and is a region corresponding to the entire area of a bottom surface of the first electrode collector plate 111. A region of the first electrode plate 110 corresponding to the first electrode collector plate 111 may be placed on the first base portion 121.

In one embodiment, the first extending portion 122 extends outwardly from each edge of the first base portion 121. When the first separator 120 and the first electrode plate 110 are aligned as described above, the first electrode tab 113 according to one embodiment extends beyond the first extending portion 122.

In one embodiment, the second separator 130 is an insulating thin film having a high ion transmissivity and a high mechanical strength, and has a thickness of 5 to 300 μm. The second separator 130 may be composed of a chemical-resistant and hydrophobic olefin polymer such as polypropylene or the like, or a sheet or non-woven fabric made of glass fiber or polyethylene or the like. The second separator 130 according to one embodiment has a multi-layered structure of a polyethylene film, a polypropylene film or combinations of these films; or a polymer film for a polymer electrolyte or a gel-type polymer electrolyte, such as polyvinylidenefluoride, polyethylene oxide, polyacrylonitrile or a polyvinylidene fluoride hexafluoropropylene copolymer. In one embodiment, the second separator 130 includes a first base portion 131 and a first extending portion 132. The second separator 130 may be placed on the first electrode plate 110. A bottom surface of the second separator 130 may be adhered to a portion of the top surface of the first electrode plate 110.

In one embodiment, the second base portion 131 is positioned above the first base portion 121, and is a region corresponding to the entire area of the first base portion 121. The second base portion 131 may be placed on a region of the first electrode plate 110 corresponding to the first electrode collector plate 111.

In one embodiment, the second extending portion 132 extends outwardly from each edge of the second base portion 131. The second extending portion 132 is positioned above the first extending portion 122, and corresponds to the entire area of the first extending portion 122. In one embodiment, a bottom surface of the second extending portion 132 is adhered to a top surface of the first extending portion 122 by a suitable method, as shown in FIG. 4. In one embodiment, the second extending portion 132 and the first extending portion 122 are adhered to each other by ultrasonic fusion. That is, according to one embodiment, the second extending portion 132 and the first extending portion 122 form a fused region by melting and adhering portions of the second extending portion 132 and the first extending portion 122 to each other.

In one embodiment, the second electrode plate 140 includes a second electrode collector plate 141, a second electrode active material layer 142 and a second electrode tab 143. The second electrode plate 140 is placed on the second separator 130. In one embodiment, a bottom surface of the second electrode 140 is adhered to a top surface of the second separator 130 using an adhesive A, for example, a polyvinylidene fluoride (PVDF) binder.

According to one embodiment, a thickness of the second electrode collector plate 141 is 3 to 500 μm. The material of the second electrode collector plate 141 is not specifically limited as long as it has a high electrical conductivity while not inducing a chemical change in the battery concerned. For example, the second electrode collector plate 141 may be made of stainless steel, aluminum, nickel, titanium, plastic carbon, or aluminum or stainless steel which is surface-treated with carbon, nickel, titanium or silver.

In one embodiment, the second electrode collector plate 141 has fine irregularities on its surface to reinforce bondability of the second electrode material layer 142. The second electrode collector plate 141 may be formed into various suitable shapes, such as a film, a sheet, a foil, a net, a porous body or the like.

In one embodiment, the second electrode collector plate 141 is placed on the second base portion 131 and corresponds to the entire area of a top surface of the second base portion 131. With regard to FIG. 6B, the second electrode collector plate 141 according to one embodiment includes a second electrode coating portion 141a and a second electrode non-coating portion 141b.

The second electrode coating portion 141a is a region coated with a second electrode active material, and the second electrode non-coating portion 141b is a region of the second collector plate 141 not coated with the second electrode active material. The second electrode coating portion 141a and the second electrode non-coating portion 141b may be positioned on a top surface and/or a bottom surface of the second electrode collector plate 141.

In one embodiment, the second electrode active material layer 142 is formed by coating the second electrode active material onto the second electrode coating portion 141a. The second electrode active material may be composed of lamellar compounds such as lithium cobalt oxide (LiCoO₂), lithium nickel oxide (LiNiO₂) or the like; compounds substituted by one or more transition metals; or lithium manganese oxide represented by chemical formula Li₁₊ₓMn₂₋ₓO₄,where x is a value from 0 to 0.33, such as LiMnO₃, LiMn₂O₃, LiMnO₂ or the like

In one embodiment, the second electrode tab 143 is formed of nickel (Ni). In one embodiment, the second electrode tab 143 is integrally provided with the second electrode collector plate 141, extending from a side of the second electrode non-coating portion 141b. In one embodiment, the second electrode tab 143 may be spaced apart from the first electrode tab 113 in a horizontal (or longitudinal) direction of the assembly block 100.

In the stacked electrode assembly 1 according to one embodiment of the present invention shown in FIG. 1, a plurality of electrode assembly blocks 100 constructed as described above are stacked. The electrode assembly blocks 100 may be aligned with respect to the first separators 120 or the second separators 130. That is, when the stacked electrode assembly 1 having the plurality of stacked electrode assembly blocks 100 is viewed from its top surface, the plurality of stacked electrode assembly blocks 100 may be aligned such that respective first separators 120 are overlapped. Alternatively, in the same context, the plurality of stacked electrode assembly blocks 100 may be aligned such that respective second separators 130 are overlapped.

The electrode assembly blocks 100 may be aligned with respect to electrode tabs including the first electrode tabs 113 and the second electrode tabs 143. That is, when the stacked electrode assembly 1 having the plurality of stacked electrode assembly blocks 100 is viewed from its top surface, the plurality of stacked electrode assembly blocks 100 may be aligned such that respective first electrode tabs 113 and/or respective second electrode tabs 143 are overlapped.

As described above, stacking and alignment is performed in units of electrode assembly blocks, thereby facilitating alignment of the multiple components included in the stacked electrode assembly 1.

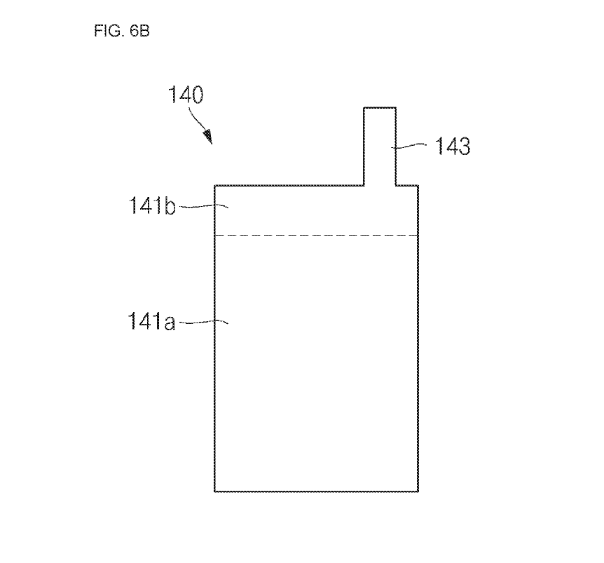

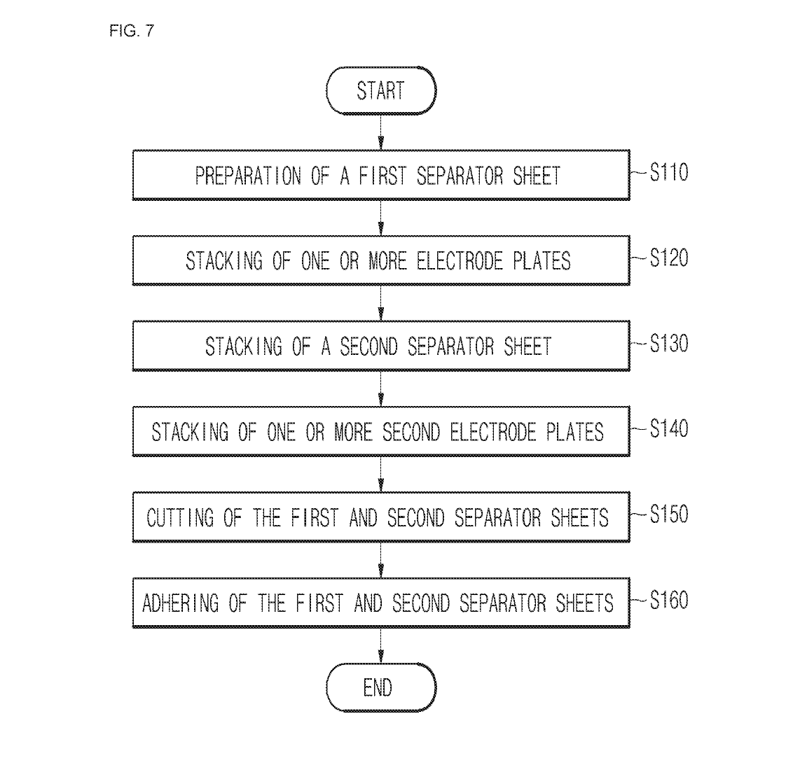

Hereinafter, a method of assembling an electrode assembly block according to an embodiment of the present invention will be described with reference to FIGS. 1 to 6B and FIGS. 7 to 13B. FIG. 7 is a flowchart schematically illustrating processing steps in a method of manufacturing an electrode assembly block according to an embodiment of the present invention. FIGS. 8 through 13B are plan views and sectional views schematically illustrating the method illustrated in FIG. 7. Throughout FIGS. 7 to 13B, elements having an identical function are provided with the identical reference numeral shown in FIGS. 1 to 6B. To clarify the processing steps in the manufacturing method, repeated explanations thereof will not be provided or brief descriptions thereof will be made.

Referring to FIG. 7, the method of manufacturing an electrode assembly block according to an embodiment of the present invention includes preparing a first separator sheet (S110), stacking one or more first electrode plates (S120), stacking a second separator sheet (S130), stacking one or more second electrode plates (S140), cutting the first and second separator sheets (S150) and adhering the first and second separators (S160).

In step S110, a first separator sheet 1200 is placed in a manufacturing process line. FIG. 8 is a plan view of the first separator sheet 1200. In one embodiment, the first separator sheet 1200 is made of the same material as the first separator 120.

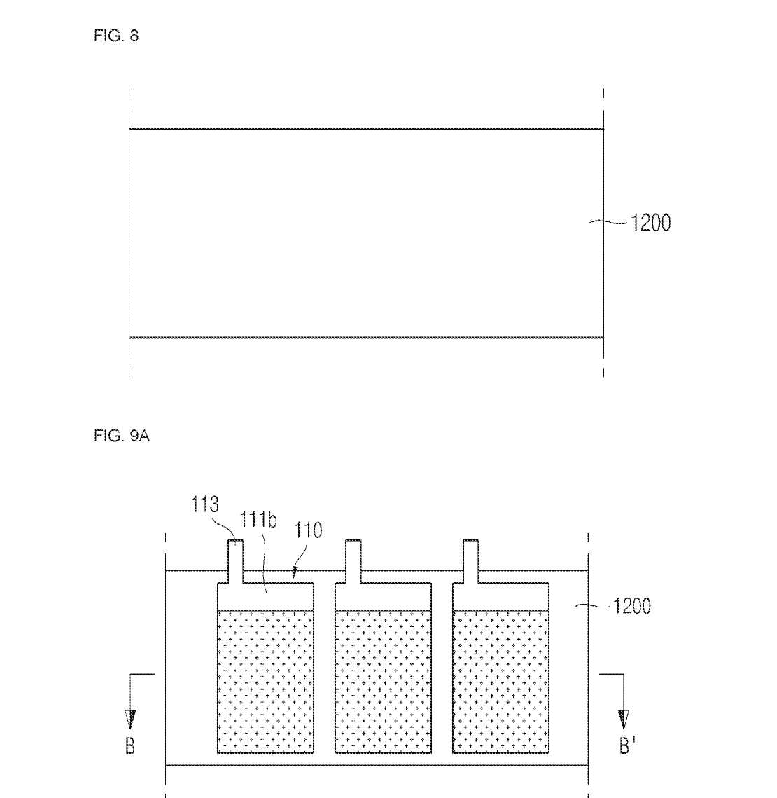

In one embodiment, step S120 includes stacking one or more first electrode plates 110 on the first separator sheet 1200 and adhering a bottom surface of each of the one or more first electrode plates 110 to the first separator sheet 1200. In the stacking of the one or more first electrode plates, one or more first electrode plates 110 are placed on a top surface of the first separator sheet 1200 such that a portion of the first electrode tab 113 of each of the one or more first electrode plates 110 protrudes from one side of the first separator sheet 1200. The one or more first electrode plates 110 are placed at a set or predetermined spacing in the horizontal (or longitudinal) direction of the first separator sheet 100. In the adhering of the one or more first electrode plates 110, a bottom surface of each of the one or more first electrode plates 110 is adhered to the top surface of the first separator sheet 1200 to prevent or protect from the one or more first electrode plates 110 from moving during the performing of subsequent processing steps. In another embodiment, the adhering of the one or more first electrode plates 110 is omitted. That is to say, since the adhering of the one or more first electrode plates 110 is performed for the purpose of preventing the one or more first electrode plates 110 from moving during the performing of subsequent processing steps, the adhering step may be omitted when movement of the one or more first electrode plates 110 is prevented or remedied by subsequent processing steps or when the one or more first electrode plates 110 are not moved during the performing of subsequent processing steps. FIG. 9A is a plan view illustrating a state in which the one or more electrode plates 110 are stacked on the top surface of the first separator sheet 1200 such that a portion of the first electrode tab 113 of each of the one or more electrode plates 110 protrudes from a side of the first separator sheet 1200. FIG. 9B is a sectional view taken along line B-B′ of FIG. 9A, illustrating the state in which the one or more first electrode plates 110 are stacked on the top surface of the first separator sheet 1200 such that a portion of the first electrode tab 113 protrudes from the first separator sheet 1200.

In one embodiment, step S130 includes providing a second separator sheet 1300 and adhering a bottom surface of the second separator sheet 1300 to a top surface of each of the one or more first electrode plates 110. In the providing of the second separator sheet 1300, the second separator sheet 1300 is placed over the entire area of the top surface of the first separator sheet 1200. In the adhering of the second separator sheet 1300, the bottom surface of the second separator sheet 1300 is adhered to the top surface of each of the one or more first electrode plates 110 using an adhesive, thereby preventing or protecting from the one or more first electrode plates 110 from moving during the performing of subsequent processing steps. The adhering of the second separator sheet 1300 to the one or more first electrode plates 110 may be omitted for any of the reasons described above in the adhering of the bottom surface of each of the one or more first electrode plates 110 to the first separator sheet 1200.

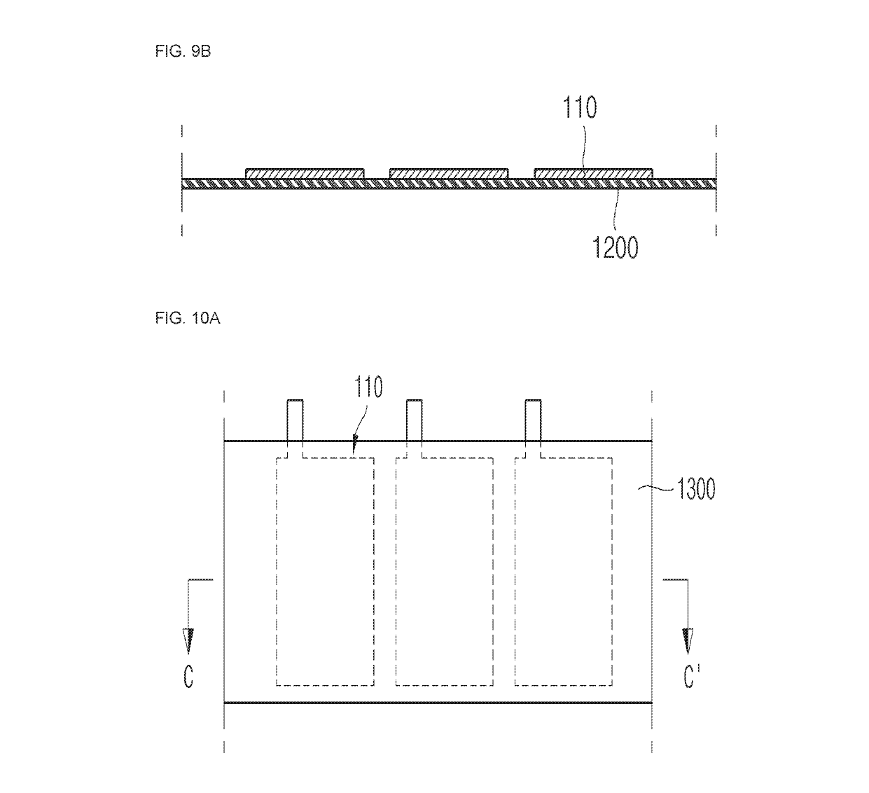

FIG. 10A is a plan view illustrating a state in which the second separator sheet 1300 is stacked on the one or more first electrode plates 110 and is covering the entire area of the top surface of the first separator sheet 1200. FIG. 10B is a sectional view taken along line C-C′ of FIG. 10A, illustrating the state in which the second separator sheet 1300 is stacked on the one or more first electrode plates 110 and is covering the entire area of the top surface of the first separator sheet 1200.

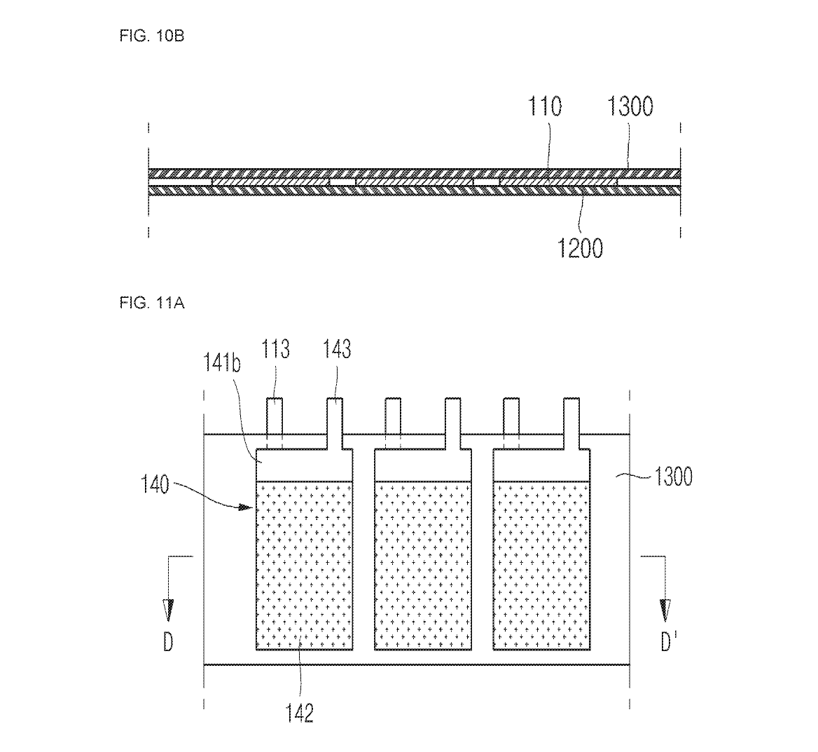

In one embodiment, step S140 includes stacking one or more second electrode plates 140 on a region of the top surface of the second separator sheet 1300 and adhering the one or more second electrode plates 140 to the second separator sheet 1300. The region of the top surface of the second separator sheet 1300 on which each of the one or more second electrode plates 140 is placed corresponds to the entire area of the top surface of one of the one or more first electrode plates 110 that are located on the opposite surface of the second separator sheet 1300. In one embodiment, each of the one or more second electrode plates 140 is placed on the second separator sheet 1300 such that a second electrode collector plate 141 of each of the one or more second electrode plates 140 is aligned with a first electrode collector plate 111 of each of the one or more first electrode plates 110 that are located on the opposite surface of the second separator sheet 1300. In one embodiment, the entire bottom surface of each of the second electrode plates 140 or a portion thereof is adhered to the top surface of the second separator sheet 1300, thereby preventing the one or more second electrode plates 140 from moving during the performing of subsequent processing steps. In one embodiment, an adhesive, for example, a PVDF binder, is used. FIG. 11A is a plan view illustrating a state in which the bottom surface of each of the one or more second electrode plates 140 is adhered to the top surface of the second separator sheet 1300. FIG. 11B is a sectional view taken along line D-D′ of FIG. 11A, illustrating the state in which the bottom surface of each of the one or more second electrode plates 140 is adhered to the top surface of the second separator sheet 1300.

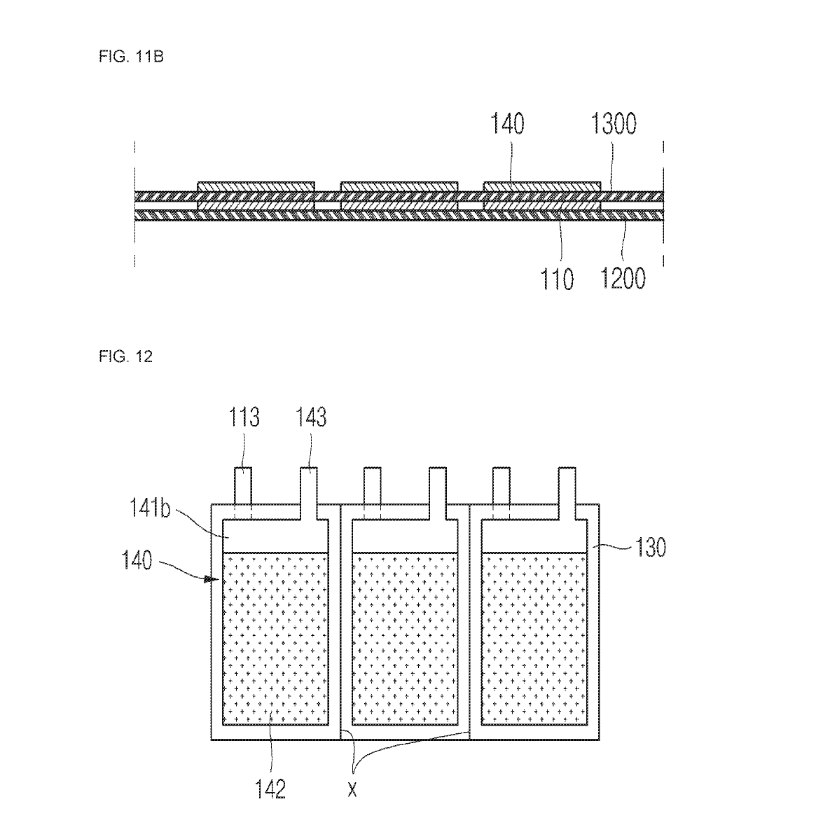

In one embodiment, step S150 includes cutting the first separator sheet 1200 and the second separator sheet 1300 into a set or predetermined size larger than each of the one or more first electrode plates 110 and the one or more second electrode plates 140. This allows a border along the edges of each of the one or more first electrode plates 110 and the one or more second electrode plates 140. In one embodiment, the first separator sheet 1200 and the second separator sheet 1300 are cut by any suitable method, for example heat cutting. FIG. 12 is a plan view illustrating a state in which the first separator sheet 1200 and the second separator sheet 1300 are cut into a set or predetermined size, leaving a border along the edges of each of the one or more first electrode plates 110 and the one or more second electrode plates 140. In FIG. 12, lines marked X indicate cutting lines.

A portion resulting from cutting the first separator sheet 1200 is called a first separator 120. Likewise, a portion resulting from cutting the second separator sheet 1300 is called a second separator 130. Thus, according to one embodiment, a first electrode plate 110 is located on a top surface of the first separator 120. The first separator 120 is larger than the first electrode plate 110 and is positioned so as to form a border along the edges of the first electrode 110. A second separator 130 having substantially identical dimensions as the first separator 120 is located on a top surface of the first electrode plate 110 and is aligned with the first separator 120 so as to also form a border along the edges of the first electrode 100. A second electrode plate 140 is located on the top surface of the second separator plate 130 and is aligned with the first electrode plate 110 so that the second separator plate 130 also forms a border along the edges of the second electrode plate 140. The border formed by the first separator 120 is called the first extending portion 122. The border formed by the second separator is called the second extending portion 132.

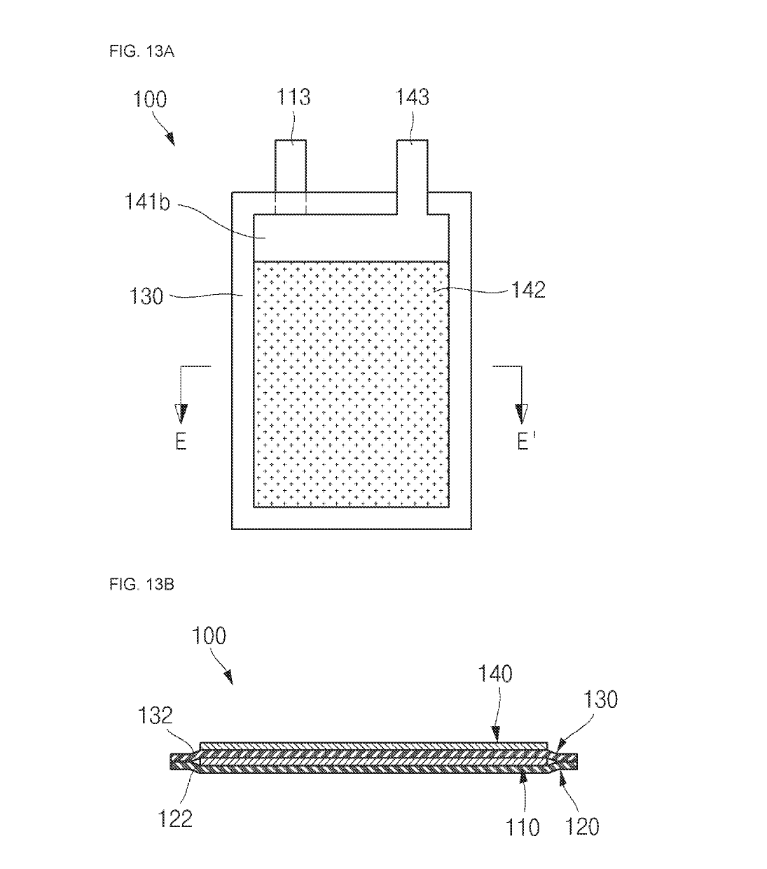

In one embodiment, step S160 includes adhering at least part of the top surface of the first separator 120 to at least part of the bottom surface of the second separator 130. That is, according to one embodiment, the top surface of the first extending portion 122 and the bottom surface of the second extending portion 132 are wholly or partially adhered to each other by any suitable method, for example by ultrasonic fusion. FIG. 13A is a plan view illustrating a state in which the top surface of the first extending portion 122 and the bottom surface of the second extending portion 132 are partially adhered to each other. FIG. 13B is a sectional view taken along line E-E′ of FIG. 13A, illustrating the state in which the top surface of the first extending portion 122 and the bottom surface of the second extending portion 132 are partially adhered to each other.

Hereinafter, a method of manufacturing a stacked electrode assembly according to an embodiment of the present invention will be described with reference to FIGS. 1 to 6B and FIGS. 14 to 17.

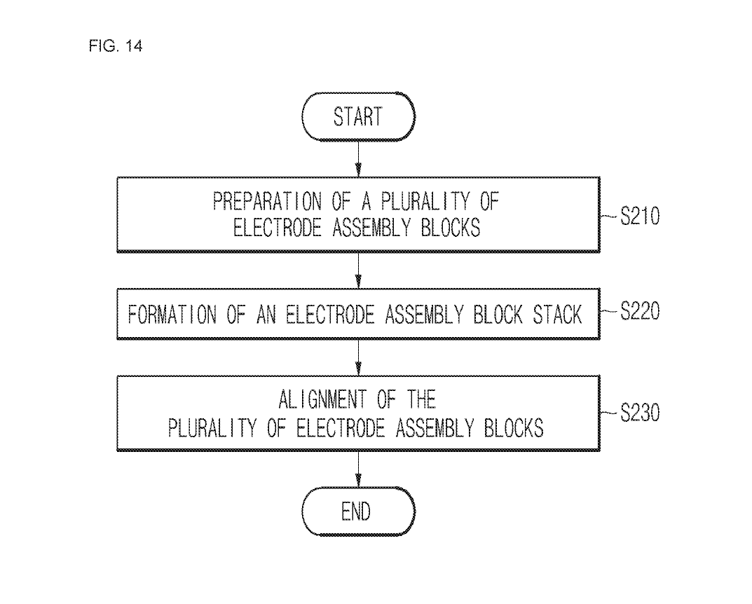

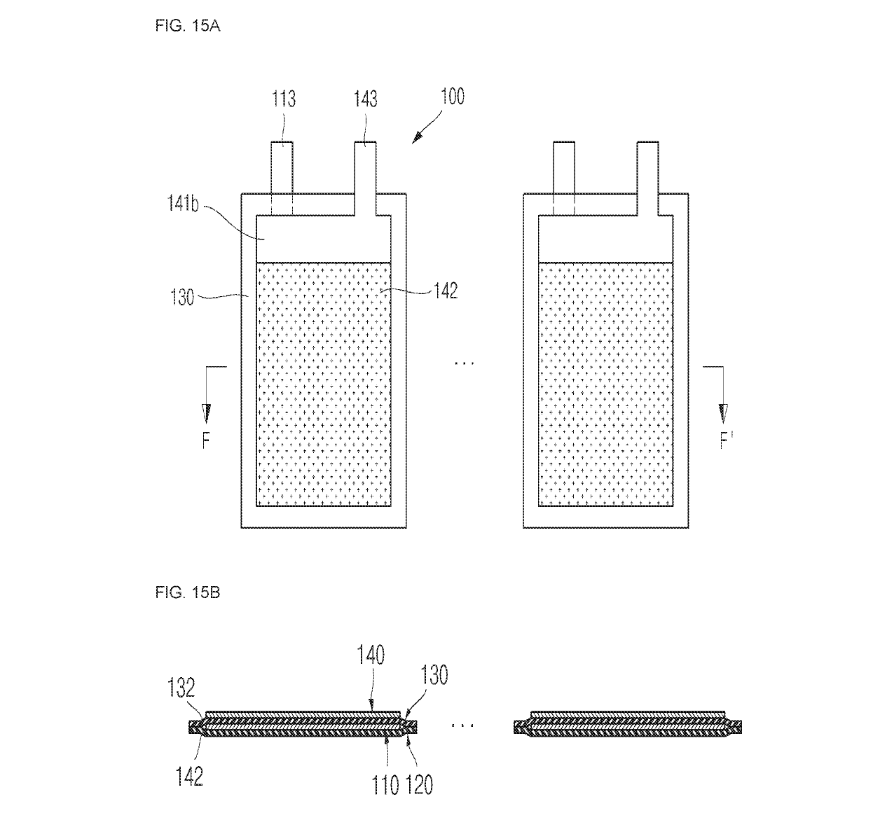

FIG. 14 is a flowchart schematically illustrating processing steps in a method of manufacturing a stacked electrode assembly according to an embodiment of the present invention. FIGS. 15A through 17 are plan views, sectional views, and a perspective view schematically illustrating processing steps in the method illustrated in FIG. 14. Throughout FIGS. 15A to 17, elements having an identical function are provided with the identical reference numeral shown in FIGS. 1 to 6B. To clarify the processing steps in the manufacturing method of the stacked electrode assembly, repeated explanations thereof will not be provided or brief descriptions thereof will be made.

The method of manufacturing a stacked electrode assembly according to an embodiment of the present invention includes preparing a plurality of electrode assembly blocks (S210), stacking the plurality of electrode assembly blocks into an electrode assembly block stack (S220) and aligning the electrode assembly blocks (S230).

In one embodiment, step S210 includes preparing a plurality of electrode assembly blocks 100, each of which is manufactured by a suitable method, for example the manufacturing method described above. FIG. 15A is a plan view of each of the plurality of electrode assembly blocks 100. FIG. 15B is a sectional view taken along line F-F′ of FIG. 15A, illustrating each of the plurality of electrode assembly blocks 100 manufactured by the above-described manufacturing method.

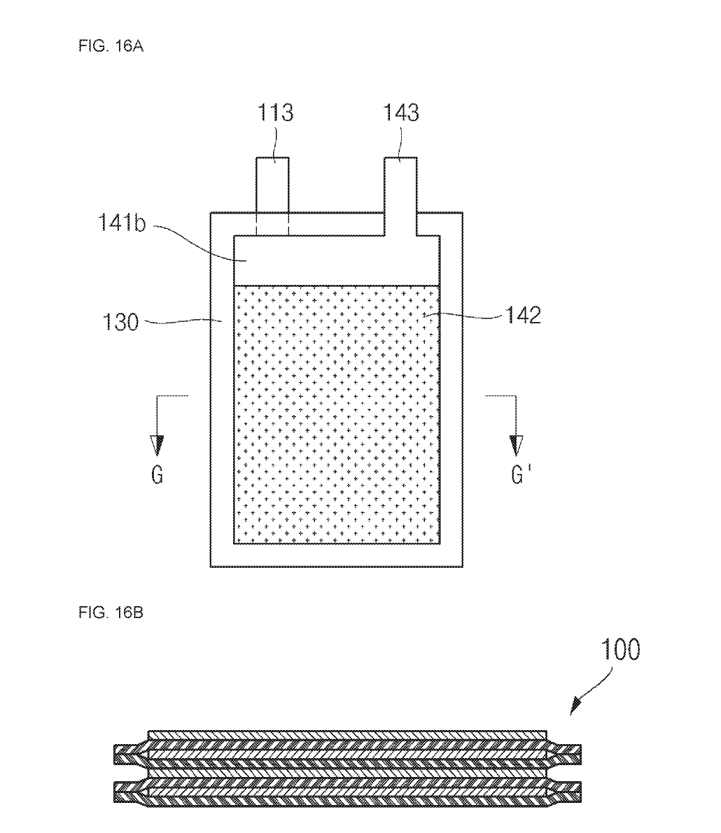

In one embodiment, step S220 includes sequentially stacking the plurality of electrode assembly blocks 100 on one another. The plurality of electrode assembly blocks 100 may be stacked based on the first separators 120 or the second separators 130. That is, in one embodiment, the plurality of electrode assembly blocks 100 may be stacked such that the first separators 120 of each of the plurality of electrode assembly blocks 100 are aligned. In another embodiment, the plurality of electrode assembly blocks 100 may be stacked such that the second separators 130 of each of the plurality of electrode assembly blocks 100 are aligned. FIG. 16A is a plan view and FIG. 16B is a front view illustrating a state in which the plurality of electrode assembly blocks 100 are sequentially stacked one on another.

In one embodiment, step S230 includes aligning the plurality of electrode assembly blocks 100 with respect to at least one of the components of each of the plurality of electrode assembly blocks 100. These components include the first separators 120, the second separators 130, the first electrode tabs 113 and the second electrode tabs 143. In other words, when or after the plurality of electrode assembly blocks 100 are sequentially stacked, they may be aligned with respect to at least one of the components of each of the plurality of electrode assembly blocks 100, including the first separators 120, the second separators 130, the first electrode tabs 113 and the second electrode tabs 143.

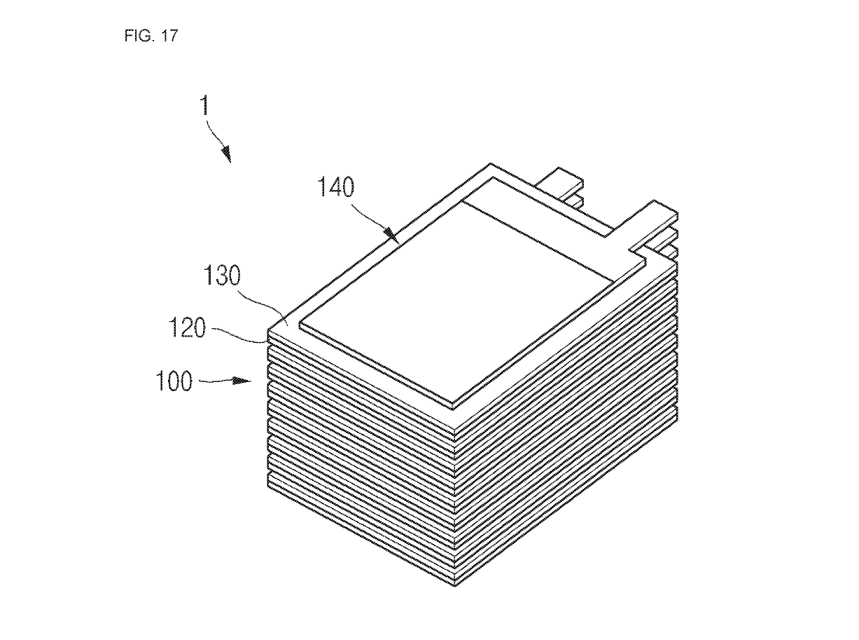

FIG. 17 is a perspective view illustrating a state in which the plurality of electrode assembly blocks 100 are aligned with respect to at least one of the first separators 120, the second separators 130, the first electrode tabs 113 and the second electrode tabs 143.

While the present invention has been described in connection with certain exemplary embodiments, its is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode assembly block comprising:
a first electrode plate comprising a first electrode collector plate and a first electrode tab;
a first separator on a bottom surface of the first electrode plate and a second separator on a top surface of the first electrode plate, to cover the first electrode collector plate between the first separator and the second separator while allowing a portion of the first electrode tab to be exposed; and
a second electrode plate on a bottom surface of the first separator or a top surface of the second separator, the second electrode plate comprising a second electrode collector plate and a second electrode tab, the second electrode plate corresponding to the first electrode plate,
wherein edge regions of the first separator and the second separator are fused together, and the second electrode plate is adhered to the first separator or the second separator.

2. The electrode assembly block of claim 1, wherein edge regions of the first separator and the second separator are ultrasonic fused together.

3. The electrode assembly block of claim 1, wherein the second electrode plate is adhered to the first separator or the second separator by an adhesive.

4. The electrode assembly block of claim 3, wherein the adhesive is a polyvinylidene fluoride (PVDF) binder.

5. The electrode assembly block of claim 1, wherein the first electrode tab and the second electrode tab are spaced apart from each other in a longitudinal direction of the electrode assembly block.

6. A secondary battery comprising an electrode assembly composed of at least two electrode assembly blocks, each of the at least two electrode assembly blocks comprising:
a first electrode plate comprising a first electrode collector plate and a first electrode tab;
a first separator on a bottom surface of the first electrode plate and a second separator on a top surface of the first electrode plate, to cover the first electrode collector plate between the first separator and the second separator while allowing a portion of the first electrode tab to be exposed; and
a second electrode plate on a bottom surface of the first separator or a top surface of the second separator, the second electrode plate comprising a second electrode collector plate and a second electrode tab, the second electrode plate corresponding to the first electrode plate,
wherein edge regions of the first separator and the second separator are fused together, and the second electrode plate is adhered to the first separator or the second separator, and
wherein the at least two electrode assembly blocks are stacked and aligned with respect to the first separator or the second separator of in at least one of the at least two electrode assembly blocks.

7. The secondary battery of claim 6, wherein, in at least one of the at least two electrode assembly blocks, edge regions of the first separator and the second separator are ultrasonic fused together.

8. The secondary battery of claim 6, wherein, in at least one of the at least two electrode assembly blocks, the second electrode plate is adhered to the first separator or the second separator by an adhesive.

9. The secondary battery of claim 8, wherein the adhesive is a polyvinylidene fluoride (PVDF) binder.

10. The secondary battery of claim 6, wherein, in at least one of the at least two electrode assembly blocks, the first electrode tab and the second electrode tab are spaced apart from each other in a longitudinal direction of the electrode assembly block.

11. A method of manufacturing an electrode assembly block, the method comprising:
stacking one or more first electrode plates on a top surface of a first separator sheet such that a portion of a first electrode tab of each of the one or more first electrode plates protrudes from one side of the first separator sheet;
stacking a second separator sheet on the one or more first electrode plates, the second separator sheet corresponding to the first separator sheet;
adhering one or more second electrode plates to the second separator sheet such that a bottom surface of each of the one or more second electrode plates is adhered to a top surface of the second separator sheet, each of the one or more second electrode plates corresponding to a respective one of the one or more first electrode plates;
cutting the first separator sheet and the second separator sheet into a set size by cutting along cutting lines spaced apart from lateral surfaces of each of the one or more first electrode plates and the one or more second electrode plates to form one or more corresponding border portions of each of the first separator sheet and the second separator sheet, the one or more corresponding border portions each extending from the lateral surfaces of each of the one or more first electrode plates and the one or more second electrode plates; and
adhering each of the one or more corresponding border portions of the first separator sheet and the second separator sheet.

12. The method of claim 11, wherein the stacking of the one or more first electrode plates comprises:
placing the one or more first electrode plates on the top surface of the first separator sheet such that a portion of the first electrode tab of each of the one or more first electrode plates protrudes from one end of the first separator sheet; and
adhering at least a portion of the bottom surface of each of the one or more first electrode plates to the top surface of the first separator sheet.

13. The method of claim 11, wherein the stacking of the second separator sheet comprises:
forming the second separator sheet by placing the second separator sheet on the one or more first electrode plates corresponding to the first separator sheet; and
adhering a portion of a bottom surface of each of the one or more second electrode plates to the top surface of the second separator sheet.

14. The method of claim 11, wherein the adhering of the one or more second electrode plate comprises adhering the one or more second electrode plates using a polyvinylidene fluoride (PVDF) binder.

15. The method of claim 11, wherein the adhering of each of the one or more corresponding border portions of the first separator sheet and the second separator sheet is performed by ultrasonic fusion.

16. A method of manufacturing a secondary battery comprising:
sequentially stacking two or more electrode assembly blocks each manufactured by the method of claim 11; and
aligning the two or more electrode assembly blocks with respect to the first separator or the second separator of at least one of the two or more electrode assembly blocks.

17. The method of claim 16, wherein the stacking of the one or more first electrode plates of at least one of the two or more electrode assembly blocks comprises:
placing the one or more first electrode plates on the top surface of the first separator sheet such that a portion of the first electrode tab of each of the one or more first electrode plates protrudes from one end of the first separator sheet; and
adhering at least a portion of the bottom surface of each of the one or more first electrode plates to the top surface of the first separator sheet.

18. The method of claim 16, wherein the stacking of the second separator sheet of at least one of the two or more electrode assembly blocks comprises:
forming the second separator sheet by placing the second separator sheet on the one or more first electrode plates corresponding to the first separator sheet; and
adhering a portion of a bottom surface of each of the one or more second electrode plates to the top surface of the second separator sheet.

19. The method of claim 18, wherein the adhering of the one or more second electrode plate comprises adhering the one or more second electrode plates using a polyvinylidene fluoride (PVDF) binder.

20. The method of claim 18, wherein the adhering of each of the one or more corresponding border portions of the first separator sheet and the second separator sheet is performed by ultrasonic fusion.

21. The electrode assembly block of claim 1, wherein the first electrode plate is a negative electrode plate, and
the second electrode plate is a positive electrode plate.
